(19) United States
(12) Patent Application Publication
(10) Pub. No.: US 2003/0228814 A1
(43) Pub. Date: Dec. 11, 2003

(54) Antibacterial packaging material including hop acids

(76) Inventors: Michael C. Barney, Elm Grove, WI (US); David S. Ryder, Mequon, WI (US); John R. Seabrooks, Richfield, WI (US)

Correspondence Address: QUARLES & BRADY LLP, 411 E. WISCONSIN AVENUE, SUITE 2040, MILWAUKEE, WI, 53202-4497, US

(21) Appl. No.: 10/165,110

(22) Filed: Jun. 7, 2002

(51) Int. Cl. B32B 9/04; B32B 29/02; B29D 23/00

(52) U.S. Cl. 442/153; 442/412; 442/413; 442/152; 428/34.1; 428/34.2

(57) ABSTRACT

An antibacterial packaging material including a layer comprising matted cellulosic fibers is disclosed. The layer comprising matted cellulosic fibers has opposed surfaces, and a hop acid selected from alpha-acids, beta-acids, and mixtures thereof is dispersed in the fibers and between the opposed surfaces. A coating of polymeric material (e.g., a polyolefin) may be disposed on the layer comprising matted cellulosic fibers to provide a coated material. The antibacterial packaging material is useful in that the growth of gram positive spore-forming bacteria such as Clostridium and/or Bacillus (e.g., Bacillus anthracis) within or on the material is inhibited. In another form, a hop acid is disposed on at least a portion of one of the surfaces of the layer comprising matted cellulosic fibers. A coating of polymeric material is disposed over the hop acid and at least over a portion of one of the surfaces of the layer comprising matted cellulosic fibers.

### CROSS-REFERENCES TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

This invention relates to an antibacterial packaging material, and more particularly to a paper or paperboard packaging material including hop acids that acts to reduce or eliminate gram positive bacteria in or on the packaging material.

2. Description of the Related Art

Paper and paperboard products have been used for years as packaging materials for consumer products. For example, paperboard containers, such as the container shown in U.S. Pat. No. 5,083,702, have been employed for holding perishable foods (e.g., milk and orange juice). Typically, such paperboard containers have been assembled from a paperboard blank, which is coated on both sides with one or more layers of a protective, thermoplastic material, such as polyethylene.

When paper and paperboard products are used for making packages or containers for food products, the fibers used to form the paper and paperboard products must meet certain standards. For example, it has been reported that the International Dairy Federation recommends a maximum bacterial load of 250 colony-forming units per gram (“cfu/g”) for paper fiber that is used to make paper and paperboard intended for use as food packages or containers. As a result, it has been proposed to use heat and/or bactericides to kill bacteria present in paper fiber before the fiber is formed into paper or paperboard. Nonetheless, certain bacteria may be difficult to kill. Among the microorganisms most difficult to kill are spore-forming bacteria. For instance, spore-formers can survive the drying temperatures which are normally employed in a papermaking machine. If these spore-formers are present in the paper fibers that are supplied to the papermaking machine, the resulting paper and paperboard are likely to have substantially more than the 250 limit of colony-forming units per gram (“cfu/g”).

The use of paper or paperboard having residual spore-forming bacteria in paperboard food containers can present problems. One problem has involved the relative lack of durability of such containers when holding liquids for longer periods of time. The liquid contents of such paperboard containers have usually tended to “wick” or seep through damaged areas of or defects in the thermoplastic coating into the paperboard base stock. This seepage of liquid through the inside, thermoplastic coating into the paperboard can provide the moisture that causes spore-forming bacteria in the paperboard to germinate. Upon germination, the bacteria may produce gas (e.g., carbon dioxide) which causes the paperboard to rupture, thereby resulting in failure of the container. In addition, pathogenic and spoilage bacteria may be released into the food product in the paperboard container, thereby increasing the risk of infection among consumers of the food product.

In particular, bacteria of the Bacillus genus form stable spores that resist harsh conditions and extreme temperatures. For example, contamination of farmlands with Bacillus anthracis leads to a fatal disease in domestic, agricultural, and wild animals. Human infection with Bacillus anthracis usually results from contact or inhalation of the spores. The inhalation form has a rapid onset and is frequently fatal. The gastrointestinal and cutaneous forms of anthrax, although less rapid, can result in fatalities unless treated aggressively. Bacillus anthracis infection in humans from animal sources is no longer common due to effective animal controls that include vaccines, antibiotics and appropriate disposal of infected livestock. However, anthrax infection still represents a significant problem due to human infection brought about by warfare and/or terrorist activities. Additionally, other members of the Bacillus genus are also reported to be the cause for many human diseases. Bacillus cereus is a common pathogen. It is involved in food borne diseases due to the ability of the spores to survive cooking procedures.

It has been known that hop extract and the alpha-acids (humulones) and the beta-acids (lupulones) derived from hops can be used to control bacteria. For example, U.S. Pat. No. 4,170,638 describes the use of raw hop extract in deodorant compositions to provide bacteriostatic activity. U.S. Pat. Nos. 5,082,975 and 5,166,449 describe the use of hydrogenated beta-acids to inhibit growth of Lactobacillus. U.S. Pat. No. 5,286,506 discloses the use of beta acids in foods to prevent the growth of Listeria. U.S. Pat. No. 5,370,863 discloses the use of lupulones, hydrogenated derivatives thereof, and mixtures thereof, in oral care compositions to inhibit Streptococcus mutans. U.S. Pat. No. 5,455,038 discloses the use of tetrahydroisohumulone or hexahydrocolupulone or mixtures thereof in a medium to inhibit Listeria. U.S. Pat. Nos. 6,313,178 and 5,827,895 and PCT International Patent Publications WO 97/31630 and WO 98/11883 describe the use of hexahydrolupulone, hexahydrocolupulone, and hexahydroadlupulone or mixtures thereof to inhibit the growth of gram positive bacteria. U.S. Pat. Nos. 6,129,907 and 6,165,447 disclose oral care compositions having hydrogenated lupulones. U.S. Pat. No. 6,251,461 describes the use of hop extracts including alpha-acids and beta-acids for controlling Clostridium and Helicobacter. PCT International Patent Publications WO 01/05254 and WO 01/06877 describe combinations of beta acids or hydrogenated beta-acids with another constituent to control Listeria. PCT International Patent Publication WO 01/26647 describes the use of alpha-acids and beta-acids to inhibit the growth of Staphylococcus aureus. The content of each of these references is incorporated herein by reference.

Therefore, there is a need for a process for treating the paper fibers used in making paper and paperboard wherein spore-forming bacteria are eliminated or reduced in the paper or paperboard formed from the paper fibers. Furthermore, there is a need for a process for treating formed paper and paperboard wherein spore-forming bacteria are eliminated or reduced in the paper or paperboard. While there is a specific need for reducing spore-forming bacteria in paper and paperboard used in the food packaging field, there is also a more general need for paper and paperboard packaging materials that have antibacterial properties.

### SUMMARY OF THE INVENTION

The foregoing needs are met by an antibacterial packaging material according to the invention. The antibacterial packaging material includes a layer comprising matted cellulosic fibers. The layer comprising matted cellulosic fibers has opposed surfaces, and a hop acid is dispersed in the fibers and between the opposed surfaces. The hop acid is preferably selected from hydrogenated iso-alpha-acids, hydrogenated beta-acids, and mixtures thereof. More preferably, the hop acid is a tetrahydro-iso-alpha-acid or a hexahydro-beta-acid. In one version of the invention, the hop acid is hexahydrocolupulone. A coating of polymeric material may be disposed on at least a portion of one of the opposed surfaces of the layer comprising matted cellulosic fibers to provide a coated material. Preferably, the polymeric material is selected from polyolefins, copolymers of polyolefins, and mixtures thereof. The antibacterial packaging material is particularly useful in that the growth of gram positive spore-forming bacteria such as Clostridium and/or Bacillus (e.g., Bacillus anthracis) within or on the material is inhibited.

In another form, an antibacterial packaging material according to the invention includes a layer comprising matted cellulosic fibers. The layer comprising matted cellulosic fibers has opposed surfaces, and a hop acid is disposed on at least a portion of one of the opposed surfaces of the layer comprising matted cellulosic fibers. A coating of polymeric material is disposed over the hop acid and at least over a portion of one of the opposed surfaces of the layer comprising matted cellulosic fibers. In this manner, a layer of hop acid is sandwiched between the layer comprising matted cellulosic fibers and the coating of polymeric material for at least a section of the material. The same hop acids and polymeric materials are suitable for this form of the invention. This antibacterial packaging material is also particularly useful in that the growth of gram positive spore-forming bacteria such as Clostridium and/or Bacillus (e.g., Bacillus anthracis) within or on the material is inhibited.

The foregoing needs are also met by a method according to the invention. The method provides a means for reducing colony forming units and killing germinating spores of gram positive spore-forming bacteria in a paper product. The method comprises providing an aqueous slurry including cellulosic fibers, adding a hop acid to the slurry, and then forming a paper product from the slurry. The paper product may be subsequently coated with a polymeric material to form a coated paper product. The coated paper product may then be formed into a container suitable for a liquid food product. In a food container constructed using a coated paper product according to the invention, seepage into the paperboard base stock will not lead to the germination and growth of bacteria as the hop acid dispersed in or on the paperboard will kill, inhibit or otherwise control the growth or proliferation of gram positive spore-forming bacteria such as Clostridium and/or Bacillus (e.g., Bacillus anthracis) within or on the material. In particular, germinating spores will be killed. Thus, rupture of the container is avoided, and pathogenic and spoilage bacteria are also not released into the food product in the food container.

In another method according to the invention, there is provided a method for reducing colony forming units and killing germinating spores of gram positive spore-forming bacteria in a coated paper product. The method comprises providing a paper product, applying a hop acid selected from the group consisting of alpha-acids, derivatives of alpha-acids, beta acids, derivatives of beta-acids, and mixtures thereof, to the paper product, and coating the paper product with a polymeric material to form a coated paper product. The coated paper product may then be formed into a container suitable for a liquid food product. In a food container constructed using a coated paper product according to the invention, seepage into the paperboard base stock will not lead to the germination and growth of bacteria as the hop acid dispersed in or on the paperboard will kill, inhibit or otherwise control the growth or proliferation of gram positive spore-forming bacteria such as Clostridium and/or Bacillus (e.g., Bacillus anthracis) within or on the material. In particular, germinating spores will be killed. Thus, rupture of the container is avoided, and pathogenic and spoilage bacteria are also not released into the food product in the food container.

Therefore, it is an advantage of the present invention to provide an antibacterial packaging material that inhibits the growth and kills germinating spores of gram positive spore-forming bacteria (such as Clostridium and/or Bacillus) within or on the material.

It is another advantage of the present invention to provide a polymer coated antibacterial packaging material that inhibits the growth and kills germinating spores of gram positive spore-forming bacteria (such as Clostridium and/or Bacillus) within or on the material.

It is yet another advantage of the present invention to provide a method for reducing colony forming units and killing germinating spores of gram positive spore-forming bacteria in a paper product.

It is still another advantage of the present invention to provide a method for reducing colony forming units and killing germinating spores of gram positive spore-forming bacteria in a polymer coated paper product.

It is a further advantage of the present invention to provide a coated paperboard food container that resists the growth of bacteria and therefore, is less prone to rupture from the gas produced by bacteria, and prevents the release of pathogenic and spoilage bacteria into the food product in the food container.

These and other features and advantages of the invention will become better understood upon consideration of the following detailed description and appended claims.

### DETAILED DESCRIPTION OF THE INVENTION

In one embodiment, the present invention is an antibacterial packaging material including a layer comprising matted cellulosic fibers. By the term “antibacterial”, it is meant that a material, at a minimum, inhibits the growth of bacteria, and preferably, destroys such bacteria as are present on the material. The layer comprising matted cellulosic fibers has opposed surfaces, and a hop acid is dispersed in the fibers and between the opposed surfaces.

The hop acid used in the present invention may be selected from n-humulone, cohumulone, adhumulone, dihydro-n-humulone, dihydrocohumulone, dihydroadhumulone, tetrahydro-n-humulone, tetrahydrocohumulone, tetrahydroadhumulone, iso-n-humulone, isocohumulone, isoadhumulone, dihydro-iso-n-humulone, dihydroisocohumulone, dihydroisoadhumulone, tetrahydro-iso-n-humulone, tetrahydroisocohumulone, tetrahydroisoadhumulone, n-lupulone, colupulone, adlupulone, dihydro-n-lupulone, dihydrocolupulone, dihydroadlupulone, tetrahydro-n-lupulone, tetrahydrocolupulone, tetrahydroadlupulone, hexahydro-n-lupulone, hexahydrocolupulone, hexahydroadlupulone, iso-n-lupulone, isocolupulone, isoadlupulone, dihydro-iso-n-lupulone, dihydroisocolupulone, dihydroisoadlupulone, tetrahydro-iso-n-lupulone, tetrahydroisocolupulone, tetrahydroisoadlupulone, hexahydro-iso-n-lupulone, hexahydroisocolupulone, hexahydroisoadlupulone, and mixtures thereof. These purified hop acids, hop acid derivatives, and hop extracts are well known in the art and are available, for example, from Miller Brewing Company (Watertown Hops Company), John I. Haas, Inc., S. S. Steiner, Inc., and Kalsec (Kalamazoo Holdings, Inc.).

The results of tests demonstrating the antibacterial action of various mixtures of hop acids on gram positive bacteria are shown in Table 1.

TABLE 1
Summary Of The Minimal Inhibitory Concentrations (ppm)
Of Hop Compounds On Gram Positive Bacteria

| | Hop Acid Mixture | | | |
|---|---|---|---|---|
| | Tetrahydro- | Dihydro- | | |
| | isohumu- | isohumu- | Hexahydro- | |
| Test Organism | lones | lones | colupulones | Colupulones |
| Pediococcus | >8 < 16^{a} | >125 < 250 | None^{b} | None |
| RB1 | | | | |
| Pediococcus | >16 < 32 | >63 < 125 | None | Not tested |
| RB2 | | | | |
| Pediococcus | >4 < 8 | >32 < 63 | None | Not tested |
| EP-404A | | | | |
| Lactobacillus | >63 < 125 | >63 < 125 | None | None |
| delbrueckii | | | | |
| PEL | | | | |
| Lactobacillus | >32 < 63 | >125 < 250 | None | None |
| plantarum | | | | |
| KGF50 | | | | |
| Lactobacillus | >32 < 63 | >63 < 125 | None | None |
| plantarum | | | | |
| KGF54 | | | | |
| Micrococcus | >16 < 32 | >16 < 32 | >6.2 < 6.3 | >12.5 < 25 |
| PRT | | | | |
| Staphylococcus | >16 < 32 | >16 < 32 | None | >6.3 < 12.5 |
| aureus | | | | |
| Streptococcus | >1 < 2 | >16 < 32 | None | None |
| pyogenes | | | | |
| Streptococcus | >4 < 8 | >8 < 16 | >0.2 < 0.4 | >25 < 50 |
| pneumoniae | | | | |
| Streptococcus | >32 < 63 | >63 < 125 | None | None |
| faecalis | | | | |
| Streptococcus | >4 < 8 | Not tested | >12.5 < 25 | >8 < 16 |
| mutans | | | | |
| Streptococcus | >13 < 25 | Not tested | Not tested | >25 < 50 |
| sanguis | | | | |
| Bacillus | >16 < 32 | >4 < 8 | >1.6 < 3.2 | >0.8 < 1.6 |
| cereus | | | | |
| Bacillus | >8 < 16 | >4 < 8 | >1.6 < 3.2 | >0.8 < 1.6 |
| subtilis | | | | |
| Listeria | >8 < 16 | >8 < 16 | >0.4 < 0.8 | >12.5 < 25 |
| monocytogenes | | | | |
| Listeria | Not tested | Not tested | >0.8 < 1.6 | Not tested |
| innocua | | | | |
| Listeria | Not tested | Not tested | >0.4 < 0.8 | Not tested |
| seeligeri | | | | |
| Propionibac- | >8 < 16 | >8 < 16 | >4 < 8 | >32 < 64 |
| terium acnes | | | | |

^{a}greater than 8 but less than 16 inhibited
^{b}None means none of the concentrations tested were found to be inhibitory.

It has been reported in U.S. Pat. No. 6,251,461 that hop extracts including a mixture of beta-acids and alpha-acids and hop extracts including beta-acids and no alpha acids provide inhibitory activity of Clostridium botulinum and Clostridium difficile spores in broth media. In particular, the hop extracts produced inhibitory activity towards eight Clostridium botulinum strains at a concentration as low as 1 ppm. Similarly, spores of Clostridium difficile strains were inhibited by the hop extracts at concentrations as low as 1 ppm.

The hop acid contained within or on the antibacterial packaging material according to the invention kills, inhibits or otherwise controls the growth or proliferation of gram positive spore-forming bacteria within or on the material. While most hop acids are to some degree effective against gram positive spore-forming bacteria (see Table 1), hydrogenated iso-alpha-acids and hydrogenated beta-acids have been found to be particularly effective in killing or inhibiting the growth of positive spore-forming bacteria. Therefore, the hop acid is preferably selected from hydrogenated iso-alpha-acids, hydrogenated beta-acids, and mixtures thereof. Most preferably, the hop acid is a tetrahydro-iso-alpha-acid or a hexahydro-beta-acid. In one version of the invention, the hop acid is hexahydrocolupulone. The hop acid is present in the antibacterial packaging material in an effective amount. By the term “an effective amount” it is meant that a sufficient amount is present to provide the desired antibacterial effect, but not so much as to cause any undesirable result. It is anticipated that a tetrahydro-iso-alpha acid concentration of at least 0.1 ppm by weight of the antibacterial packaging material will provide effective bacterial control to the material. It is anticipated that a hexahydro-beta-acid (e.g., hexahydrocolupulone) concentration of at least 0.1 ppm by weight of the antibacterial packaging material will provide effective bacterial control to the material.

This embodiment of an antibacterial packaging material according to the invention may be manufactured using a method according to the invention which uses a Fourdrinier paper making machine such as that described in U.S. Pat. No. 4,145,249, which is incorporated herein by reference. First, a pulp stock comprising a slurry of cellulosic fibers in water is prepared using conventional, well known techniques. The hop acid is then added to the pulp stock. A colloidal suspension of the hop acid may be prepared and added to the pulp stock, or alternatively a solution of the hop acid is prepared and added to the pulp stock. The use of a colloidal suspension or a solution of the hop acid is dictated by the loading of hop acid desired in the pulp stock and the solubility of the hop acid in the liquid carrier (e.g., water). Preferably, the hop acid is added to the pulp stock in an amount such that the final antibacterial packaging material (which in this example is a paper product) includes 0.1 ppm to 10,000 ppm hop acid by weight. As used herein, the term “paper product” includes hardboard, fiberboard, paperboard, paper, and molded-pulp products formed from pulps including cellulosic fibers.

The aqueous slurry including cellulosic fibers and hop acid is then delivered from the headbox of the Fourdrinier paper making machine onto the upper surface of the Fourdrinier wire screen. The wire screen is supported by a first roll and a second roll and as the aqueous slurry including cellulosic fibers and hop acid passes over suction boxes in its travel from the first roll to the second roll, water is withdrawn from the pulp stock through the wire screen, leaving a thin formation of self-supporting, matted cellulosic fibers on the upper surface of the wire screen. The sheet of formed matted cellulosic fibers is then peeled from the wire screen and is directed to the pressing and drying sections of the paper machine, wherein most of the remaining water is removed. The hop acid is retained as a dispersion in the matted cellulosic fibers thereby providing antibacterial properties to the resulting antibacterial packaging material.

In another embodiment, an antibacterial packaging material according to the invention includes a layer comprising matted cellulosic fibers. The layer comprising matted cellulosic fibers has opposed surfaces, and a hop acid is disposed on at least a portion of one of the opposed surfaces of the layer comprising matted cellulosic fibers. This embodiment of an antibacterial packaging material according to the invention is manufactured using an alternative method according to the invention. In this method, a packaging material (i.e., a paper product) is manufactured as described above in a Fourdrinier paper making machine using a pulp stock having no hop acids. A hop acid selected from the group consisting of alpha-acids, derivatives of alpha-acids, beta acids, derivatives of beta-acids, and mixtures thereof is then applied to the surface of the packaging material by immersing the packaging material in the hop acid and/or spraying the hop acid on the surface of the packaging material. An apparatus suitable for applying hop acid to the surface of the packaging material using spraying and/or immersion techniques can be found in U.S. Pat. No. 4,888,155, which is incorporated herein by reference. An antibacterial packaging material is formed by this process.

An antibacterial packaging material manufactured using the above two methods will have hop acid dispersed within or on the antibacterial packaging material. The antibacterial packaging material may then be further processed to include a coating of a polymeric material. The coating of polymeric material can be applied to the antibacterial packaging material using any convenient application technique known in the art, including, but not limited to, extrusion coating, co-extrusion coating, adhesive or extrusion lamination, spray coating, dip coating, doctoring and combinations thereof. Suitable polymeric materials for the coating include, without limitation, polyolefins and polyolefin copolymers and mixtures thereof, such as those described in U.S. Pat. No. 6,228,201, which is incorporated herein by reference. One preferred coating material is polyethylene. The coating may be disposed on a portion of the antibacterial packaging material, or on the entire surface of the antibacterial packaging material. When the antibacterial packaging material includes surface areas coated with hop acid, the polymeric material coating is disposed over the hop acid and at least over a portion of the surfaces of the antibacterial packaging material.

In the food packaging field, it is particularly desirable to eliminate or control the growth of the gram positive spore-forming bacteria, such as Clostridium and Bacillus, and advantageously, the antibacterial packaging material according to the invention kills, inhibits or otherwise controls the growth or proliferation of these gram positive spore-forming bacteria. Thus, the antibacterial packaging material according to the invention finds particular utility in the food packaging field. One specific, non-limiting, exemplary use of the antibacterial packaging material according to the invention is as a core layer that is coated with a polymeric material as described above and thereafter formed into a food container. In a food container constructed using a polymer coated antibacterial packaging material according to the invention, seepage into the antibacterial packaging material base stock will not lead to the germination and growth of bacteria as the hop acid dispersed in or on the antibacterial packaging material will kill, inhibit or otherwise control the growth or proliferation of gram positive spore-forming bacteria (such as Clostridium and/or Bacillus) within or on the material. Thus, rupture of the container is avoided, and pathogenic and spoilage bacteria are also not released into the food product in the food container.

The coated antibacterial packaging material (i.e., paper product) may be formed into a food carton using known methods. Food cartons are in widespread and versatile use for the storage of liquid food materials. One type of carton or container is the commonly recognizable gabletop carton. The gabletop carton includes four side panels which are finished, at the top, with a peaked, gable-like configuration. Typically, these food cartons are used for packaging and storing liquid foods such as milk, juice and the like, as well as other, consumer liquid products. Traditionally, such cartons are formed from “blanks” which are formed or erected and transported into a filling apparatus in which the carton is filled and the top or gable portion folded and sealed. The blanks are shipped and stored unformed or flat. The cartons are generally erected within the filling machine. The construction of such cartons can be found in U.S. Pat. Nos. 6,325,878 and 5,848,748, which are incorporated herein by reference. In a food carton constructed using a coated paper product according to the invention, seepage into the antibacterial packaging material base stock will not lead to the germination and growth of bacteria as the hop acid dispersed in or on the antibacterial packaging material will kill, inhibit or otherwise controls the growth or proliferation of gram positive spore-forming bacteria within or on the material. Thus, rupture of the container is avoided, and pathogenic and spoilage bacteria are also not released into the food product in the food container.

While the antibacterial packaging material (especially when prepared as a paper product) finds particular usefulness in the food packaging field, the use of the antibacterial packaging material is not limited to this field. In fact, the antibacterial properties of a material according to the invention (and in particular the antibacterial activity versus gram positive spore-forming bacteria within or on a material) are useful in any application where the surface or the interior of the walls of a packaging material need to be kept bacteria free. For example, an envelope constructed with an antibacterial packaging material according to the invention may kill, inhibit or otherwise control the growth or proliferation of gram positive spore-forming bacteria (e.g., Bacillus anthracis) in contact with the envelope surfaces.

Therefore, it can be seen that there has been provided paper and paperboard packaging materials that have antibacterial properties. Also, there has been provided a process for treating the paper fibers used in making paper and paperboard wherein spore-forming bacteria are eliminated or reduced in the paper or paperboard formed from the paper fibers, and a process for treating formed paper and paperboard wherein spore-forming bacteria are eliminated or reduced in the paper or paperboard.

Although the present invention has been described with reference to certain embodiments, one skilled in the art will appreciate that the present invention can be practiced by other than the described embodiments, which have been presented for the purpose of illustration and not of limitation. Therefore the scope of the appended claims should not be limited to the description of the embodiments contained herein.

What is claimed is:

1. An antibacterial packaging material comprising:
a layer having opposed surfaces, the layer comprising matted cellulosic fibers; and
a hop acid dispersed in the fibers and between the opposed surfaces, the hop acid being selected from the group consisting of alpha-acids, derivatives of alpha-acids, beta acids, derivatives of beta-acids, and mixtures thereof.

2. The material of claim 1 wherein:
a coating of polymeric material disposed on at least a portion of one of the opposed surfaces of the layer comprising matted cellulosic fibers.

3. The material of claim 2 wherein:
the polymeric material is selected from polyolefins, copolymers of polyolefins, and mixtures thereof.

4. The material of claim 1 wherein:
the hop acid is selected from hydrogenated iso-alpha-acids, hydrogenated beta-acids, and mixtures thereof.

5. The material of claim 1 wherein:
the hop acid is a tetrahydro-iso-alpha-acid.

6. The material of claim 1 wherein:
the hop acid is a hexahydro-beta-acid.

7. The material of claim 1 wherein:
the hop acid is hexahydrocolupulone.

8. The material of claim 1 wherein:
the growth of gram positive spore-forming bacteria within or on the material is inhibited.

9. The material of claim 1 wherein:
the layer comprising matted cellulosic fibers has a concentration of the hop acid of at least 0.1 ppm by weight of the layer comprising matted cellulosic fibers.

10. An antibacterial packaging material comprising:
a layer having opposed surfaces, the layer comprising matted cellulosic fibers;
a hop acid disposed on at least a portion of one of the opposed surfaces of the layer comprising matted cellulosic fibers, the hop acid being selected from the group consisting of alpha-acids, derivatives of alpha-acids, beta acids, derivatives of beta-acids, and mixtures thereof; and
a coating of polymeric material disposed over the hop acid and at least over a portion of one of the opposed surfaces of the layer comprising matted cellulosic fibers.

11. The material of claim 10 wherein:
the polymeric material is selected from polyolefins, copolymers of polyolefins, and mixtures thereof.

12. The material of claim 10 wherein:
the hop acid is selected from hydrogenated iso-alpha-acids, hydrogenated beta-acids, and mixtures thereof.

13. The material of claim 10 wherein:
the hop acid is a tetrahydro-iso-alpha-acid.

14. The material of claim 10 wherein:
the hop acid is a hexahydro-beta-acid.

15. The material of claim 10 wherein:
the hop acid is hexahydrocolupulone.

16. The material of claim 10 wherein:
the growth of gram positive spore-forming bacteria within or on the material is inhibited.

17. The material of claim 10 wherein:
the layer comprising matted cellulosic fibers has a concentration of the hop acid of at least 0.1 ppm by weight of the layer comprising matted cellulosic fibers.

18. A method for reducing colony forming units and killing germinating spores of gram positive spore-forming bacteria in a paper product, the method comprising:
providing an aqueous slurry including cellulosic fibers;
adding a hop acid selected from the group consisting of alpha-acids, derivatives of alpha-acids, beta acids, derivatives of beta-acids, and mixtures thereof, to the slurry; and
forming a paper product from the slurry.

19. The method of claim 18 further comprising:
coating the paper product with a polymeric material to form a coated paper product.

20. The method of claim 18 further comprising:
forming the coated paper product into a container suitable for a liquid food product.

21. The method of claim 18 wherein the step of adding the hop acid to the slurry comprises:
forming a colloidal suspension of the hop acid, and
adding the suspension to the slurry.

22. The method of claim 18 wherein the step of adding the hop acid to the slurry comprises:
forming a solution of the hop acid, and
adding the solution to the slurry.

23. The method of claim 18 wherein:
the hop acid is selected from hydrogenated iso-alpha-acids, hydrogenated beta-acids, and mixtures thereof.

24. The method of claim 18 wherein:
the hop acid is a tetrahydro-iso-alpha-acid.

25. The method of claim 18 wherein:
the hop acid is a hexahydro-beta-acid.

26. The method of claim 18 wherein:
the hop acid is hexahydrocolupulone.

27. The method of claim 18 wherein:
the hop acid is added to the slurry in an amount such that the slurry has a concentration of the hop acid of at least 0.1 ppm.

28. The method of claim 18 wherein:
the gram positive spore-forming bacteria is Clostridium and/or Bacillus.

29. The method of claim 18 wherein:
the gram positive spore-forming bacteria is Bacillus anthracis.

30. A method for reducing colony forming units and killing germinating spores of gram positive spore-forming bacteria in a coated paper product, the method comprising:
providing a paper product;
applying a hop acid selected from the group consisting of alpha-acids, derivatives of alpha-acids, beta acids, derivatives of beta-acids, and mixtures thereof, to the paper product; and
coating the paper product with a polymeric material to form a coated paper product.

31. The method of claim 30 further comprising:
forming the coated paper product into a container suitable for a liquid food product.

32. The method of claim 30 wherein the step of applying the hop acid to the paper product comprises:
forming a colloidal suspension of the hop acid, and
spraying the suspension on the paper product.

33. The method of claim 30 wherein the step of applying the hop acid to the paper product comprises:
forming a colloidal suspension of the hop acid, and immersing the paper product in the suspension.

34. The method of claim 30 wherein the step of applying the hop acid to the paper product comprises:
forming a solution of the hop acid, and
spraying the solution on the paper product.

35. The method of claim 30 wherein the step of applying the hop acid to the paper product comprises:
forming a solution of the hop acid, and
immersing the paper product in the suspension.

36. The method of claim 30 wherein:
the hop acid is selected from hydrogenated iso-alpha-acids, hydrogenated beta-acids, and mixtures thereof.

37. The method of claim 30 wherein:
the hop acid is a tetrahydro-iso-alpha-acid.

38. The method of claim 30 wherein:
the hop acid is a hexahydro-beta-acid.

39. The method of claim 30 wherein:
the hop acid is hexahydrocolupulone.

40. The method of claim 30 wherein:
the gram positive spore-forming bacteria is Clostridium and/or Bacillus.

41. The method of claim 30 wherein:
the gram positive spore-forming bacteria is Bacillus anthracis.
